(19) United States
(12) Patent Application Publication
(10) Pub. No.: US 2004/0088208 A1
(43) Pub. Date: May 6, 2004

(54) Creating and monitoring automated interaction sequences using a graphical user interface

(76) Inventors: Bernhard M. H. Runge, Mannheim (DE); Melissa Hostetler, Redwood City, CA (US); Deborah Rodgers, Palo Alto, CA (US); Elizabeth Bacon, Cupertino, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/283,329

(22) Filed: Oct. 30, 2002

(51) Int. Cl. G06F 17/60

(52) U.S. Cl. 705/10

(57) ABSTRACT

Automated interaction sequences for interactions with a target group during a marketing campaign are created and monitored using a graphical user interface. A received user input graphically creates an interaction sequence that has one or more actions associated with a target group. The interaction sequence is executed to cause performance of the actions in an automated manner. Responses to the actions are automatically processed.

### TECHNICAL FIELD

This document relates to creating and monitoring automated interaction sequences using a graphical user interface.

### BACKGROUND

The growing complexity of marketer's expectations paired with the fragmentation of existing tools makes it difficult to track and understand specific customer needs. This gap between the information needed and the capabilities of existing business tools makes it difficult to plan, gather feedback, and analyze results of marketing campaigns.

### SUMMARY

In one general aspect, automated interaction sequences for interactions with a target group during a marketing campaign are created and monitored using a graphical user interface. A received user input graphically creates an interaction sequence that has one or more actions associated with a target group during a marketing campaign. The interaction sequence is executed to cause the actions to be performed in an automated manner. Responses to the actions are automatically processed.

Implementations may include one or more of the following features. For example, the actions may include a first action and a second action. A dependency may be applied to the second action such that the second action depends on an automated response processed in response to the first action. The actions may include a send e-mail action, a send mail action, and/or an initiate phone call action.

The user may segment the target group by applying filters to the target group. In one implementation, the user may segment the target group by dragging an attribute near the target group. One or more action areas in which to drop the attribute are presented to the user when the attribute is dragged near the target group. The user may split the target group into multiple target groups and create a separate interaction sequence for each of the target groups.

The user may monitor the interaction sequence. The interaction sequence may be modified based on the automatically processed responses. The interaction sequence may include a marketing interaction sequence.

In another general aspect, a marketing campaign may be created and monitored using a graphical user interface. A marketing interaction sequence is created using the graphical user interface. The marketing interaction sequence includes one or more actions associated with a customer target group, and is released for automatic execution. Customer feedback related to the actions is received and automatically processed during the execution of the marketing interaction sequence.

Implementations may include one or more of the following features for use with the general aspect described above for the graphical user interface. For example, the marketing interaction sequence may be monitored using the graphical user interface. The marketing interaction sequence may include a first action and a second action that is dependent on automatically-processed customer feedback that is related to the first action.

The customer target group may be segmented by dragging an attribute near the customer target group, picking an action area in which to drop the attribute from action areas presented when the attribute is dragged near the customer target group, and dropping the attribute in the picked action area. Automatic error checks may be conducted when the marketing interaction sequence is released.

In another general aspect, a graphical user interface for creating and monitoring automated interaction sequences with a target group during a marketing campaign includes a launch window that permits selection of an attribute, a build window that permits display of an interaction sequence having one or more actions related to the selected attribute for interacting with a target group during a marketing campaign, and an action window that permits defining of the actions graphically represented in the build window.

Implementations may include one or more of the following features. For example, the graphical user interface may include a filter window that permits segmenting of the selected attribute, an alerts window that permits display of one or more alerts, a details window that permits display of textual feedback related to selections made in other windows of the graphical user interface, and/or a monitoring window that permits monitoring of automated responses to the interaction sequence.

These general and specific aspects may be implemented using a system, a method, or a computer program, or any combination of systems, methods, and computer programs.

Other features and advantages will be apparent from the description and drawings, and from the claims.

### DESCRIPTION OF DRAWINGS

FIG. 1 is a block diagram of an exemplary computer system.

FIG. 2 is a block diagram of an exemplary Graphical User Interface (GUI).

FIG. 3 is a block diagram of an exemplary launch window from the GUI of FIG. 2.

FIG. 4 is a block diagram of an exemplary filter window from the GUI of FIG. 2.

FIG. 5 is a block diagram of an exemplary build window from the GUI of FIG. 2.

FIGS. 6a and 6b are block diagrams of exemplary icons from the GUI of FIG. 2.

FIG. 7 is a block diagram of an exemplary alert window from the GUI of FIG. 2.

FIG. 8 is a block diagram of an exemplary details window from the GUI of FIG. 2.

FIGS. 9a and 9b are block diagrams of exemplary action windows from the GUI of FIG. 2.

FIG. 10 is a block diagram of an exemplary build window tab from the GUI of FIG. 2.

FIG. 11 is a block diagram of an exemplary GUI.

FIG. 12 is a flow chart illustrating a process for creating and monitoring automated interaction sequences.

FIGS. 13-23 are block diagrams of an overview of an exemplary illustration of the GUI.

Like reference symbols in the various drawings indicate like elements.

### DETAILED DESCRIPTION

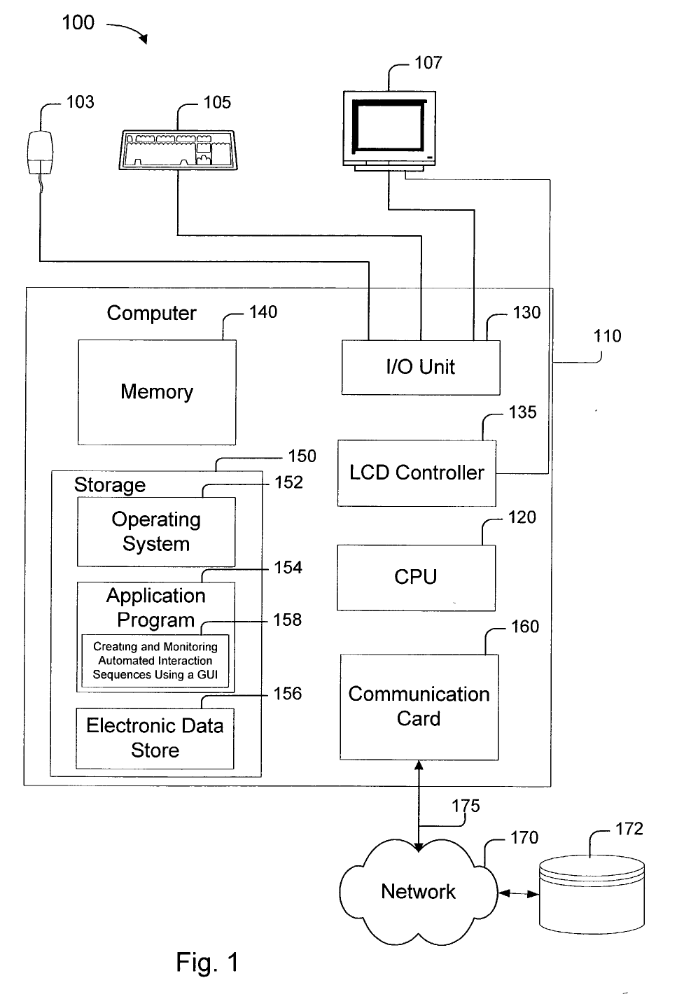

FIG. 1 illustrates an exemplary computer system 100. The system 100 may include various input/output (I/O) devices (e.g., mouse 103, keyboard 105, and display 107) and a general purpose computer 110 having a central processor unit (CPU) 120, an I/O unit 130, memory 140, and storage 150. Storage 150 may store machine-executable instructions, data, and various programs, such as an operating system 152 and one or more application programs 154, all of which may be processed by CPU 120. Storage 150 also includes an electronic data store 156 that may be used to store and maintain a data source.

System 100 also may include a communications card or device 160 (e.g., a modem and/or a network adapter) for exchanging data with a network 170 using a communications link 175 (e.g., a telephone line, a wireless network link, a wired network link, or a cable network). Examples of a network 170 include the Internet, the World Wide Web, a wide area network (WAN), a local area network (LAN), analog or digital wired and wireless telephone networks (e.g., PSTN, ISDN, and xDSL), radio, television, cable, satellite, and/or any other delivery mechanism for carrying data. An electronic data store (e.g., a database) 172 may be connected to the network 170.

Other examples of system 100 may include a handheld device, a workstation, a server, a device, a component, other equipment, or some combination of these capable of responding to and executing instructions in a defined manner.

An exemplary application program 154 may include an application program for creating and monitoring automated interaction sequences using a Graphical User Interface (GUI) 158. Application program 158 may be used in concert with other similar computer systems 100 that include application program 158 connected through network 170. For example, application program 158 may create and release an interaction action to be performed by another computer system 100 that is connected through network 170. Feedback from the interaction action may be provided from the one computer system 100 to the computer system 100 that originated the action. In one exemplary context, application program 158 may be used to seamlessly integrate planning, feedback, and analysis aspects of a marketing campaign. More specifically, for example, application program 158 may be used to create both high-level and detailed interaction plans and to provide real-time feedback that updates the interaction plans.

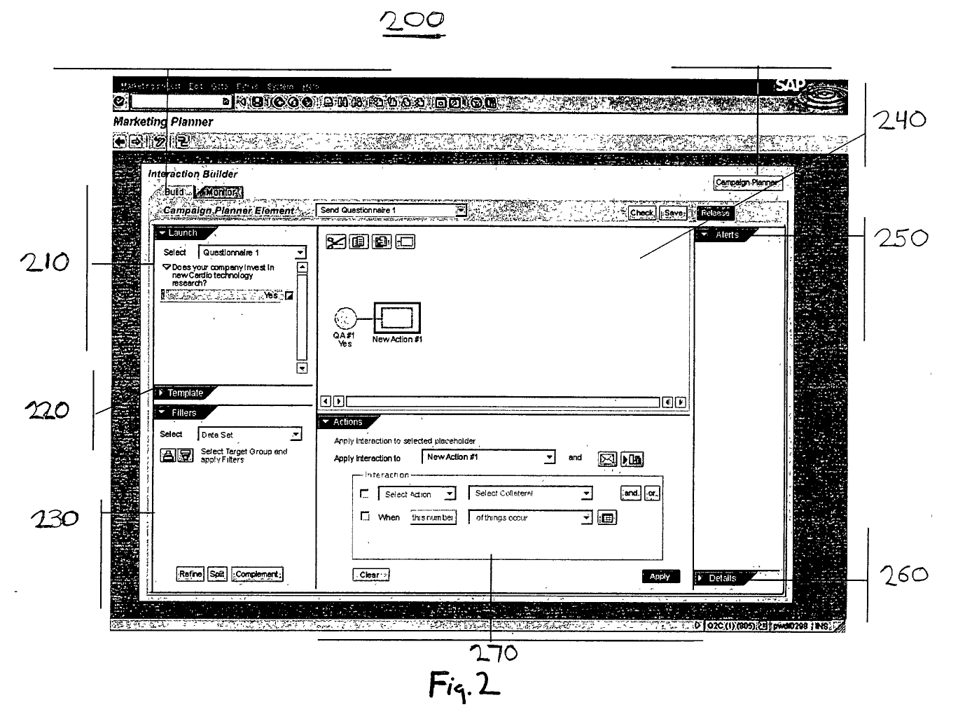

FIG. 2 illustrates an exemplary GUI 200 to create an automated interaction sequence. GUI 200 may be included as part of the application program 158 (FIG. 1) for creating and manipulating an automated interaction sequence. In one implementation, GUI 200 may be used to create and release interaction sequences. In one exemplary context, GUI 200 may be used in a marketing context to enable marketing professionals to design a marketing campaign having multiple interaction sequences. These sequences may be executed to perform in an automated fashion so as to receive and account for customer feedback between sequences. In this exemplary context, GUI 200 enables marketing automation to include the integration of building and executing a marketing campaign along with customer response analysis. Automated marketing decisions that may be built into the marketing campaign may take automated customer responses into account. GUI 200 is not meant to be limited to a marketing context and may be used in other contexts.

GUI 200 typically includes one or more windows, such as, for example, a launch window 210, a template window 220, a filter window 230, a build window 240, an alerts window 250, a details window 260, and an action window 270. The windows 210-270 may be arranged and sized by the user and may include features such as, for example, auto-generated scroll bars, tabs, and drop-down menu selectors. The windows 210-270 may be expanded and minimized using selector arrows that operate to expand and minimize the windows 210-270. Each of the windows 210-270 may be displayed individually or in combination with one or more of the other windows 210-270.

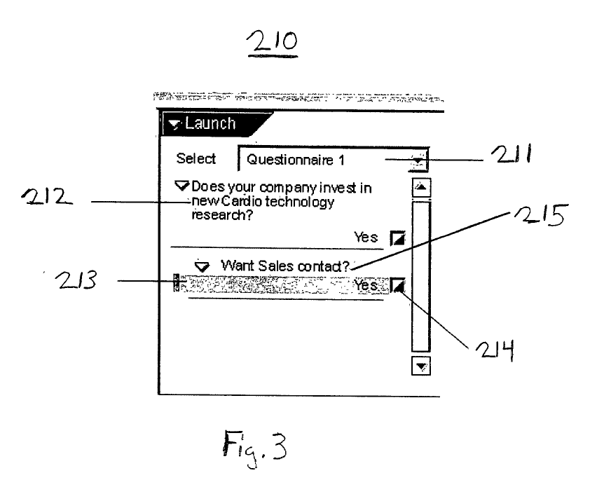

Launch window 210 enables a user to link interactions with responses received from an interaction sequence. Launch window 210 provides an area for a user to contextually track the work when planning and building an interaction by providing visibility into campaign attributes that require interactions in a format that also functions as an interaction building checklist. Launch window 210 also includes a “checklist” indicator for tracking interaction development. Launch window 210 enables a user to organize progress by campaign attributes. Individual interaction strings can be built over a period of time, and then the entire set may be released when the user is ready to execute the automated plan. FIG. 3, discussed below, illustrates launch window 210 in more detail.

Template window 220 may display one or more typical interaction strings for use as templates. The interaction strings may include default typical interaction strings or interaction strings that have been created and saved by a user for use as templates.

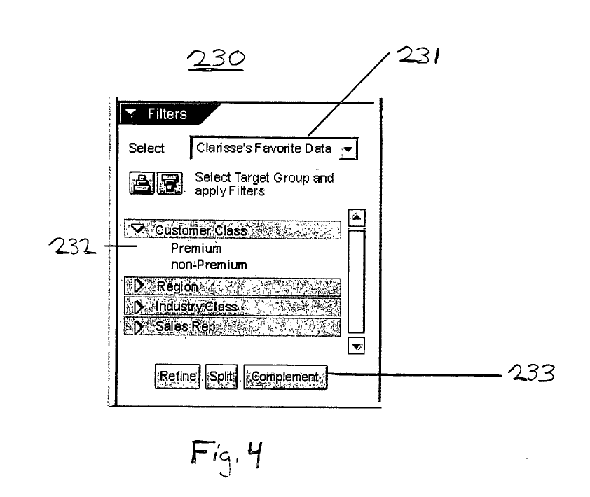

Filter window 230 may display attributes and tools for a user to manipulate a data source. For example, filter window 230 may include tools for segmenting a data source to create a particular profile or target group from the data source. FIG. 4, discussed below, illustrates filter window 230 in more detail.

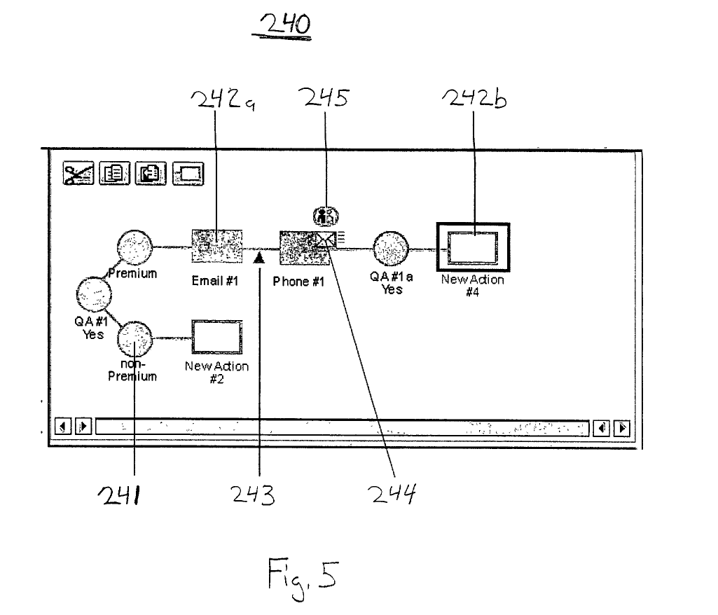

Build window 240 may display an area used to graphically create, track, and manipulate interaction sequences. FIG. 5, discussed below, illustrates build window 240 in more detail.

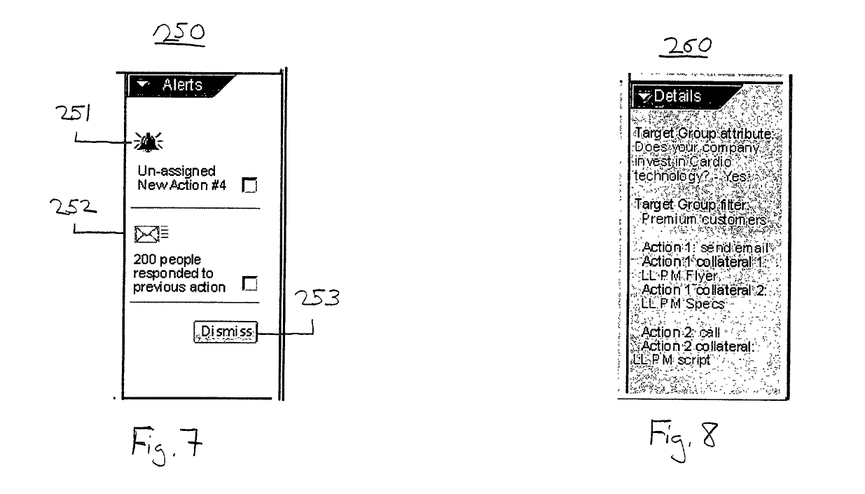

Alerts window 250 may display one or more alerts and messages to a user. Alerts window 250 may provide interaction feedback to the user. FIG. 7, discussed below, illustrates alerts window 250 in more detail.

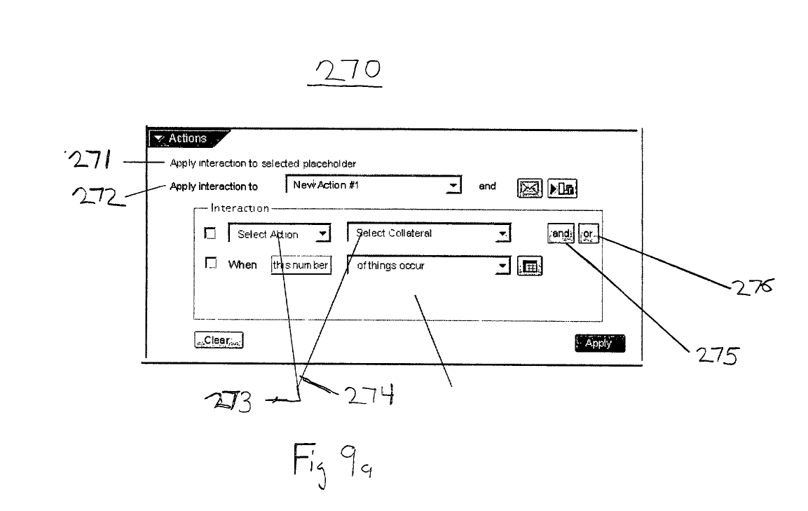

Details window 260 may display textual feedback for selections made in other windows. For example, details window 260 may display textual feedback for a selection made in launch window 210, template window 220, filter window 230, build window 240, alert window 250, and/or action window 270. FIG. 8, discussed below, illustrates details window 260 in more detail.

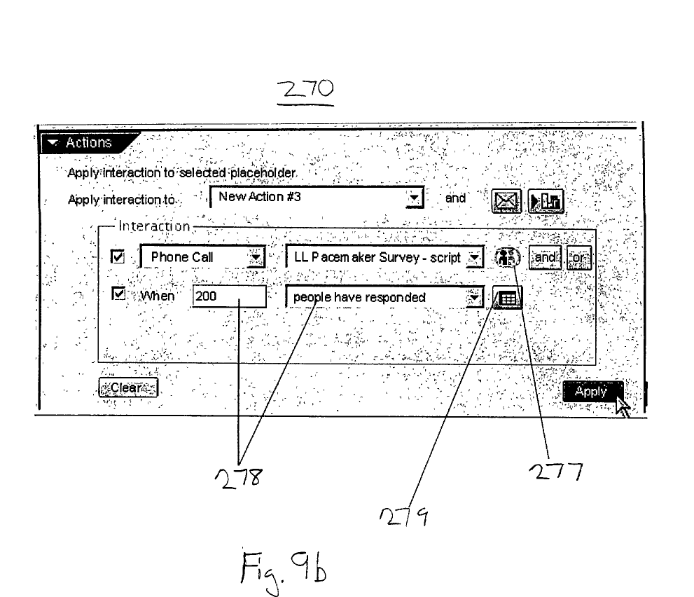

Action window 270 may display one or more tools for specifying actions, dependencies, and associated campaign elements. FIGS. 9a and 9b, discussed below, illustrate action window 270 in more detail.

FIG. 3 illustrates an exemplary launch window 210 that typically includes attributes that are used to trigger interaction scenarios. The attributes that may be used to trigger an interaction scenario may include, for example, questions and answers from questionnaires, target groups, and web data. Launch window 210 typically includes a drop-down menu 211, a related listing of attributes 212, a color field 213, icons 214, and a listing of additional attributes 215. To create an interaction sequence, the user may select a campaign element type from the drop-down menu 211. In this example, the user has selected “Questionnaire 1” as the campaign element type from the drop-down menu 211. The listing may be predetermined to reflect those campaign elements derived from customer feedback that may serve to initiate interactions.

Once a selection has been made from the drop-down menu 211, the launch window 210 is populated with possible attribute options 212 and nested attribute options 215 for originating an interaction sequence. The related listing of attributes 212 may be derived from the selected campaign element in the drop-down menu 211. The listing of attributes 212 may be used to build interactions. In this example, launch window 210 is populated with an attribute that is a question from Questionnaire 1, namely, “Does your company invest in new Cardio technology research?” 212 and a nested attribute that also is a question from Questionnaire 1, namely, “Want Sales contact?” 215.

In one implementation, a user may only build interactions associated with a single attribute at one time. Selection of an attribute from the listing of attributes 212 may be indicated visually in the color field 213. The selection of an attribute from the launch window 210 typically populates the build window 240. An icon 214 within the launch window 210 may be used to indicate differing interactions states. In one implementation, the feedback displayed in the icon 214 reflects data within one or more interaction strings attached to the selected attribute. Examples of interaction states include: not selected, partially complete, complete, checked, and rule conflict.

Launch window 210 also may display additional attributes 215. The additional attributes 215 may be associated hierarchically in relation to a base attribute. For example, if an interaction string calls out active campaign elements (e.g., campaign elements that are designed to receive additional feedback) the additional set of interaction attributes 215 may be displayed within the launch window 210 as a subset of the first attribute. This enables a user to plan for splits within interaction strings based upon anticipated feedback loops.

Campaign elements may include items or action that are related to and may be associated with an action that is part of the interaction sequence. For example, in the marketing context, campaign elements may include marketing material, send-outs, an asset file, an attachment, and a survey form. Active campaign elements include campaign elements that are designed to receive additional feedback (e.g., customer feedback). In one exemplary implementation, campaign elements may be referred to as collateral, as is illustrated in one or more of the figures.

Each attribute set 212 and 215 may be collapsible/expandable. Additionally, the launch window 210 may be resized and typically includes an auto-generated scroll bar.

In one implementation, additional attributes 215 may not appear as part of launch window 210, but may instead appear in a different window of GUI 200 such as filters window 230. In this case, for example, the additional attributes 215 may be used to filter or re-segment target groups that are a part of an interaction sequence.

FIG. 4 illustrates an exemplary filter window 230 that typically includes a selection area 231, an attribute area 232, and action buttons 233. Filter window 230 enables a user to perform filtering operations using selected attributes including applying additional data attribute criteria to a data source based on new data received as interactive feedback.

More specifically, for example, the selection area 231 may be used to select an attribute set in order to further manipulate the set. The attribute set may be selected using a drop-down list that is included as a part of the selection area 231. The content of the attribute set may be predetermined and labeled by the user, and may be provided by a data source that is stored remotely and/or locally in an electronic data store.

Once an attribute set has been selected from the selection area 231, the attribute area 232 is populated with the attribute set. The attribute set has one or more attribute categories that may be collapsed and expanded as necessary to reveal sub-attributes. When an attribute category or a sub-attribute is selected, a definition of the attribute category or sub-attribute may be displayed in the details window 260.

The action buttons 233 may be selected to perform operations that apply the selected attributes to a selected data source in a particular manner. In one implementation, the action buttons 233 may represent Boolean-type operations that apply the selected attributes to a selected data source in a Boolean-type manner. For example, the “Refine” action button may operate like a Boolean AND operator and the “Complement” action button may operate like a Boolean AND NOT operator. The “Split” action button may be used to divide the selected data source into one or more groups where the number of groups may be determined by the number of selected attributes applied to the selected data source.

Additionally or alternatively, selected attributes may be applied to selected groups in the build window 240 by dragging the selected attribute, picking an action area (e.g., refine, split, or complement) that is presented when the attribute is dragged near a selected group, and dropping the attribute in an action area. When the attribute is dropped in a picked action area, the appropriate action is performed. A history of attributes applied to a group may be viewed in the details window 260 by selecting a group.

Filter window 230 may be collapsed and expanded as necessary by the user. Additionally, filter window 230 may be resized and typically includes an auto-generated scroll bar.

In one implementation, filters window 230 may be used to re-segment selected groups in the build window 240 based on data gathered during the course of the interaction sequence. For example, in the marketing context, the user may divide a customer target group according to customer responses to a questionnaire distributed as part of an interaction sequence, and specify differing follow-up actions for each group. Thus, the data attributes within the filters window 230 may be used to conduct local resegmentation. In one implementation, the data attributes in the filter window 230 may be tied to active campaign elements that collect feedback within an interaction sequence.

FIG. 5 illustrates an exemplary build window 240. Build window 240 enables a user to create interaction sequences. Build window 240 typically includes a display area for graphically representing the interaction sequences. The interaction sequences may be represented by one or more different objects, such as, for example, flow chart shapes, connectors, geometric shapes, icons, text, and other visual and textual identifiers.

More specifically, in one implementation, build window 240 may include graphical representations for a target group 241, actions 242a and 242b, dependencies 243, messages 244, and active campaign elements 245. In this example, target group 241 is represented by a circular icon. Interaction strings may be initiated by a target group 241 that may be generated by the selection of an attribute 212 or 215 (FIG. 3) from the launch window 210 (FIG. 3). Using the attributes from the filter window 230 (FIG. 2), a target group may be further segmented.

Typically, a placeholder for an action 242a may appear when a target group 241 is generated. In this instance, actions 242a and 242b are graphically represented by a rectangular icon. Action 242a represents an action that has been defined as indicated by the shading in the rectangular area. Action 242b represents an action placeholder that has appears when a target group is generated.

A dependency 243 may be represented by a triangular icon in the build window 240. A dependency 243 represents a rule that has been defined that affects actions 242a and 242b. In this instance, the dependency 243 appears prior to an action that is affected by the dependency.

In some instances, an action may have associated messages 244. Messages icon 244 provides a visual confirmation that the message function has been selected and is associated with a particular action. Additionally, a visual indication may be provided if an action is associated with an active campaign element 245.

In one implementation, icon labels may be auto-generated and sequentially labeled by default for the different components in the build window 240. For example, a second new action that has been dragged and dropped in the build window 240 may be labeled by default (e.g., “New Action #2). After selecting a specific action to associate with the new action, the label may become auto-generated and sequentially labeled based on the selected action type (e.g., “Send E-mail #1”).

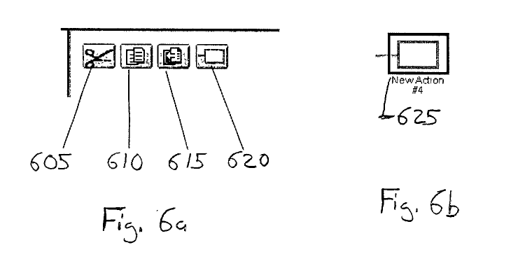

Build window 240 may include one or more tool bars and indicator icons. FIG. 6a illustrates an exemplary tool bar that may be used in conjunction with build window 240. The tool bar may be configured by the user or may be populated with icons by default. The tool bar may include a cut tool 605, a copy tool 610, a paste tool 615, and an add action tool 620. The cut tool 605 enables a user to cut one or more highlighted components of an interaction string and place the cut components on a clipboard. The copy tool 610 enables a user to copy one or more highlighted components of an interaction string and place the copied components on a clipboard. The paste tool 615 enables a user to attach data from the clipboard to a highlighted point in an interaction string. The add action tool 620 enables a user to create a new action placeholder using the context menu. The new action typically attaches to a highlighted target group or interaction string.

FIG. 6b illustrates an example when a component 625 has been selected. In this example, when the component 625 is selected, the component is highlighted to provide visual feedback to the user.

GUI 200 supports drag and drop functionality and drag, pick, and drop functionality within windows and between windows of the GUI 200. In one implementation, for example, drag and drop may be used within the build window 240 to perform numerous operations, such as, for example, to disconnect, adjust and reconnect interaction nodes. The drag and drop functionality may automatically generate connector lines for interaction sequences. For instance, if a user copies an action and drags the action to another interaction sequence, a connector line may appear to indicate potential insertion points for the selected object when the user moves the cursor near an interaction sequence.

In one implementation, for example, drag, pick, and drop may be used to drag an object, pick an action area that may be presented when the object is dragged near another object, and drop the object in the picked action area causing the picked action to be performed. For instance, a data attribute may be dragged from the filters window 230 near a target group in the build window 240. When the data attribute is dragged near the target group, one or more action areas may be presented to the user. The user may pick one of the action areas and drop the data attribute in the action area to perform the picked action.

FIG. 7 illustrates an exemplary alerts window 250. Alerts window 250 provides the user with a visual indication (e.g., graphical and textual) of system-generated and user-generated visual indicators. For example, one type of system-generated indicator may include an alert 251. Alert 251 may be generated dynamically, without being predefined by the user, to alert the user to potential conflicts that have occurred while building an interaction sequence. Additionally or alternatively, an alert 251 may be generated when a “check” function is run. Typically, an alert 251 has to be acknowledged by resolving or dismissing the alert 251 before a created interaction can be released.

One example of an alert 251 is an alert that may be received upon selecting from the build window 240 an action that is associated with a global rule. A default action may be displayed and an alert may be generated.

As another example, a user-generated indicator may include a message 252. Message 252 may be created by the user and is associated with actions and dependencies that are defined in the action window 270.

In one implementation, an alert 251 and/or a message 252 may be selected (e.g., by double-clicking). Selecting the alert 251 or the message 252 may open the interaction sequence that triggered the alert 251 or the message 252. A specific portion of the interaction sequence may be highlighted to indicate the portion that relates to the alert 251 or the message 252. This enables a user to quickly navigate through the GUI 200 to resolve alerts 251 and/or messages 252.

A dismiss button 253 may be used to dismiss an alert 251 or a message 252. In one implementation, alerts 251 and messages 252 may be dismissed by selecting the check box associated with the alert 251 and/or the message 252 and then selecting the dismiss button 253.

FIG. 8 illustrates an exemplary details window 260. Details window 260 dynamically displays information according to selections made in one or more of the other windows of GUI 200. For example, details window 260 may display target group attributes, target group filters, actions and campaign elements attached to a target group, and secondary interaction sequences. Thus, when a graphical representation is selected in one of the other windows of GUI 200, detailed textual information related to the selected graphical representation may be displayed in the details window 260.

FIGS. 9a and 9b illustrate exemplary actions windows 270. An actions window 270 may be the primary definition space for specifying interaction activity. In actions window 270, users may select and define actions, assign campaign elements, and specify dependencies within interaction strings. In one implementation, the user may define an action by first selecting a graphical representation of an action in the build window 240. Selecting an action in the build window 240 associates the actions in the actions window 270 with a specific graphical representation in the build window 240.

After an action placeholder has been selected in the build window 240, the user may define details for the selected placeholder in the actions window 270. If an action placeholder has not been selected, instructional text 271 may be automatically generated and displayed to permit the user to select an icon. An action placeholder may be selected in different ways. For example, the action placeholder may be selected directly by highlighting the icon in the build window 240. Alternatively, the action placeholder may be selected using the selection window 272. Selection window 272 may include a drop-down list of choices. Selection window 272 may be automatically populated when an action is selected in the build window 240.

The select action window 273 may be used to choose an action type. In one implementation, the action type may be predefined to be an action, such as, for example, send, call, generate lead, create opportunity, mail, and/or e-mail. Actions may include “and/or” functionality to represent alternate scenarios, such as, for example, multiple “or” dependencies.

The select campaign element window 274 may be used to select one or more campaign elements. A drop-down list may be used to display a range of choices for the user. The range of choices for the campaign elements may be predefined. The range of campaign elements choices may be tied to a data source. Active campaign elements include campaign elements that contain attributes that can drive interactions. In addition to campaign elements identified for a specific campaign, the user may have access to and be able to select non-campaign-specific campaign elements. The range of choices available in the select campaign elements window 274 may depend on the selection made in the select action window 273. For example, the selection of “send e-mail” in the select action window 273 would eliminate the choice of “direct mail” campaign elements from the select campaign elements window 274.

Multiple campaign elements may be attached together by selecting the “and” button 275. Alternate campaign elements may be indicated by selecting the “or” button 276. Selection of either the “and” button 275 or the “or” button 276 creates an additional select campaign elements window 274. In this manner, a user may associate multiple campaign elements with a single action, and may specify, for example, secondary and tertiary campaign elements. In the marketing context, the ability to specify multiple campaign elements may serve, for example, to avoid inventory backlogs.

Referring to FIG. 9b, an active campaign elements button 277 may be selected to indicate a possibility for new interaction of specific campaign elements having associated variables in the database.

In one implementation, actions may need to take place either subsequent to a specific occurrence or within a certain time frame. These parameters may be indicated by using dependency windows 278. For instance, dependencies may be related to dates, an amount of time passing, a specified number of occurrences, and/or a specified percentage of occurrences. Dependencies may include “and/or” functionality to represent alternate scenarios, such as, for example, multiple “or” dependencies.

In one example, dependency windows 278 enable a user to select a date (e.g., using the calendar icon) or to define a specific occurrence. For example, in the marketing context, a user may want to send a follow-up e-mail after 200 customers respond to a flyer. The dependency “when 200 people have responded” may be indicated in dependency windows 278. A range of choices for a type of dependencies may be predefined or may be defined by the user as the dependency is created.

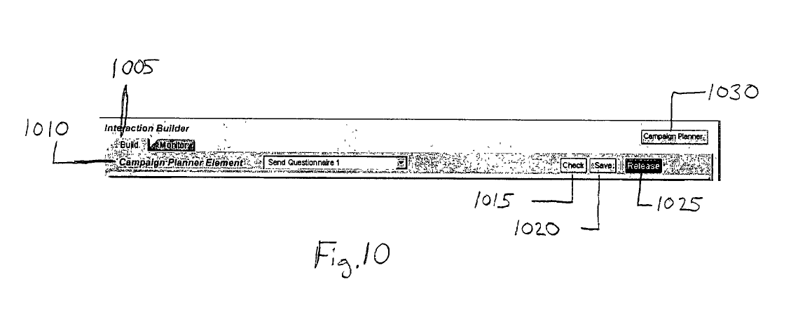

FIG. 10 illustrates an exemplary build tab 1005 for GUI 200. The build tab 1005 includes a campaign planner element window 1010, a check button 1015, a save button 1020, a release button 1025, and a campaign planner button 1030. Campaign planner element window 1010 displays the campaign planner element associated with a set of interaction sequences. This field may be automatically populated or manually populated, for example, by using the drop-down list to select the campaign element.

Check button 1015 may be used to check interaction sequences for errors or rule conflicts. When the check button 1015 is selected, the interaction data is reviewed and the alerts window 250 may be populated with conflicts that require resolution. Save button 1020 may be used to save work on the interaction sequences.

Release button 1025 may be used to release created interaction sequences into the database. Typically, an interaction sequence is released to become active and trigger the automated interactions including responses. When the release button 1025 is selected, a pop-up window (not shown) may be presented to indicate outstanding alerts. Campaign planner button 1030 may be used to toggle between GUI 200 and other programs.

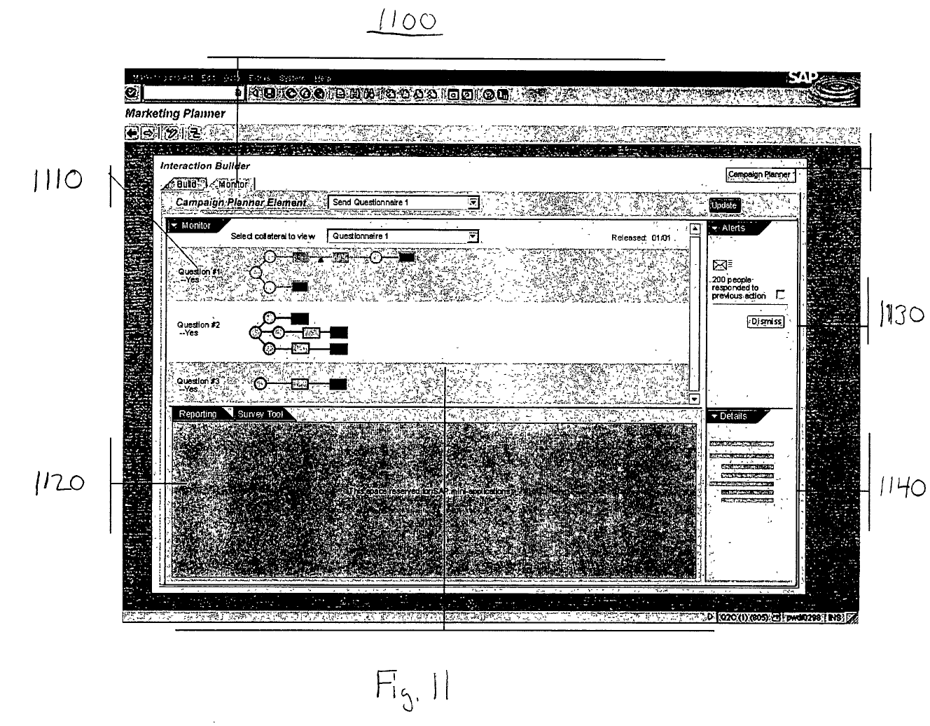

FIG. 11 illustrates an exemplary GUI 1100 to monitor one or more aspects of a campaign. GUI 1100 enables performance of multiple monitoring tasks. GUI 1100 may include one or more windows, such as, for example, an interaction sequence window 1110, a mini-applications window 1120, an alerts window 1130, and a details window 1140.

Interaction sequence window 1110 provides a high-level view of all of the interaction sequences created for a single campaign.

For example, a user may view one or more interaction trees associated with a campaign element. The user may view the details for interaction elements in the details window. The alerts window provides indications of alerts and messages. The progress of one or more interaction sequences may be monitored. The information in GUI 1100 may be updated by selecting the update button.

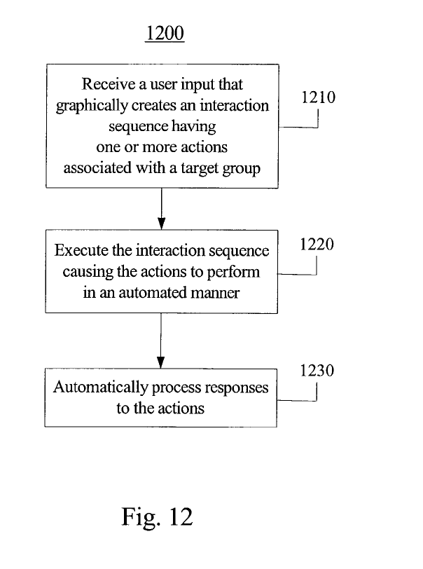

FIG. 12 illustrates a flow chart of an exemplary process 1200 for creating and monitoring automated interaction sequences. Process 1200 typically includes receiving a user input that graphically creates an interaction sequence having one or more actions associated with a target group (step 1210). When the interaction sequence is executed, the actions are performed in an automated manner (step 1220). Responses to the actions are automatically processed (step 1230).

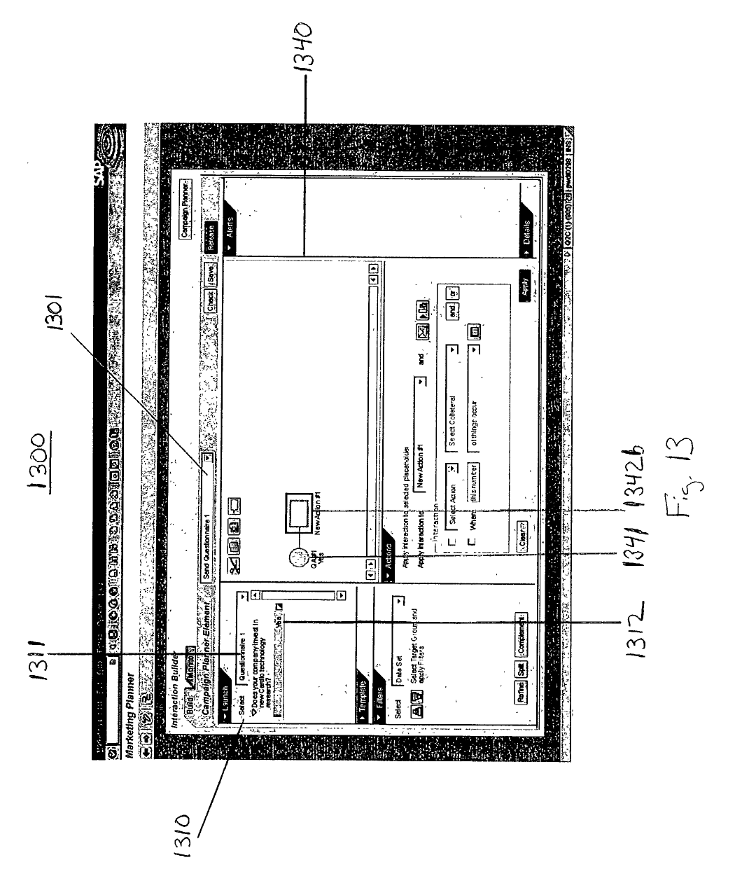

Process 1200 is described in more detail below with respect to one exemplary illustration depicted in FIGS. 13-23. FIGS. 13-23 illustrate process 1200 in the context of creating and monitoring interaction sequences for a marketing campaign. The exemplary illustration is provided as an example and is not meant to limit the types of data and data sources that may be manipulated using the GUIs and the process. Nor is it meant to limit the context to creating and monitoring interaction sequences for marketing purposes.

FIG. 13 illustrates an exemplary GUI 1300 for a user to plan and create a marketing campaign. Campaign planner element window 1310 enables the user to select a campaign element for which to plan the marketing campaign. The user may begin planning interactions by making a selection from the drop-down menu 211 in the launch window. In this example, the user selects a campaign questionnaire from the drop-down menu 211. The drop-down menu 211 displays one or more of the campaign elements associated with the campaign supported by this interaction. When the user selects the appropriate campaign element, “Questionnaire 1,” from the drop-down menu 211, the launch window is populated with attributes related to the campaign element that can be used to drive interaction scenarios. In this example, these attributes are derived from the pairing of questions and potential answers.

Once the user has selected the campaign elements and populated the launch window, the user selects the specific attribute 1312 to drive the first interaction sequence. Upon attribute selection 1312, the build window 1340 is populated with an icon representing the selected attribute as a target group 1341. An action placeholder 1342b also may be attached to the initial target group 1341 generated through attribute selection. The action placeholder 1342b typically is selected automatically.

In one implementation, GUI 1300 enables the user to create interaction sequences associated with one attribute at a time. Once interactions have been built, the user can view all interaction strings associated with a specific campaign using the monitor GUI.

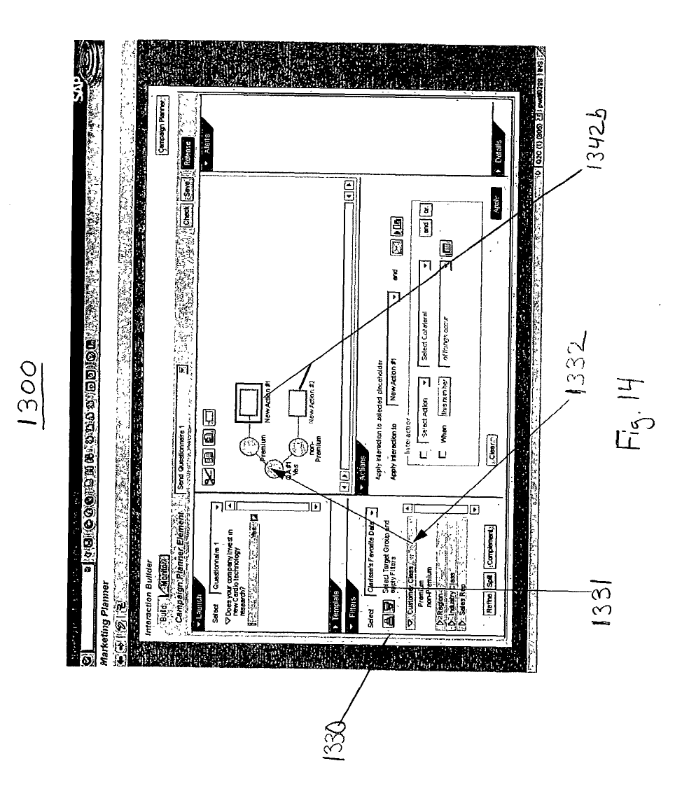

FIG. 14 illustrates an exemplary GUI 1300 that is presented to a user when the user further manipulates a target group. For example, in the marketing context, the user may perform additional segmentation of the target groups before planning interaction sequences.

In this example, the user may specify different interactions sequences for premium and non-premium customers. In order to specify different interaction sequences, the user begins by selecting a filter set from the drop-down list in the selection area 1331 at the top of the filters window 1330. When the selection is made, the filters window 1330 is populated with attribute categories and attributes 1332. The user may apply the attributes 1332 to “Premium customers” and segment the target group by splitting the group based on the data attribute (i.e., splitting the group between Premium and Non-premium). An attached action placeholder 1342b is automatically created by default. This enable the user to plan different interaction scenarios for each grouping. In this manner, the user is able to combine new and existing customer data during a campaign for more lucrative use of customer touch points.

In this example, the user may manipulate the target group in different ways. For example, the user can use either the drag-pick-and-drop functionality or can select the filter target and either refine, complement, or split by highlighting a filter and selecting one of the buttons displayed in the lower portion of the filters window 1330.

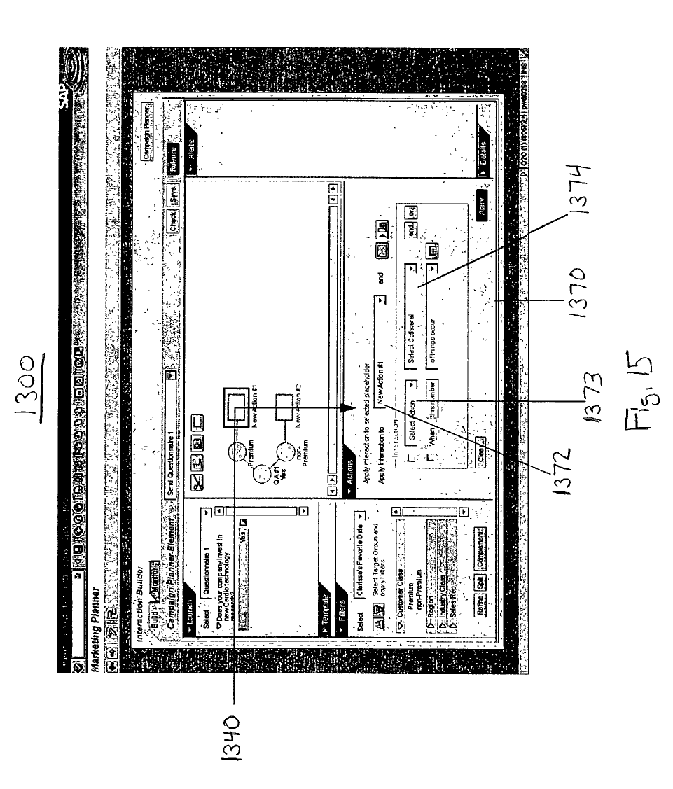

FIG. 15 illustrates an exemplary GUI 1300 that is presented to the user when the user specifies action sequences. First, the user selects an action in the build window 1340. The user then begins to define the highlighted action in the actions window. The selected action in the build window 1340 is displayed within the “Apply interaction to” window 1372. The user may define the action type by using the drop down list “Select Action” 1373. In this case, the user selects “send email.” These actions may be preconfigured. The action type selected may determine the contents of the next drop-down list of campaign elements 1374.

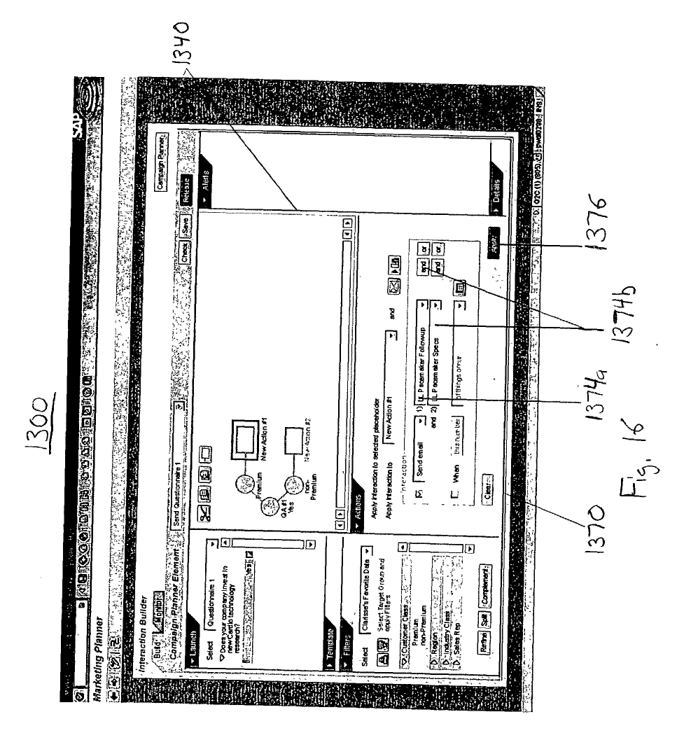

FIG. 16 illustrates an exemplary GUI that is presented to the user when the user defines actions using the actions window 1370. Once the user has selected an action, campaign elements 1374a and 1374b, if appropriate, may be selected. In this case, the user associates two campaign elements 1374a and 1374b with the action “Send email.” The drop down list may be used to select the first campaign element 1374a. Then, the user selects the “And” button to indicate the need for an additional campaign element 1374b. When the And button is selected, the action window 1370 generates an additional field for campaign element selection 1374b. The user can then specify the additional campaign element for the selected action. This process may be repeated as necessary.

Alternatively, the user may use the Or button to specify alternate, as opposed to additional, campaign elements. Once the action and all associated campaign elements have been defined, the user selects the apply button 1376 to apply the specified information to the highlighted action in the build window 1340.

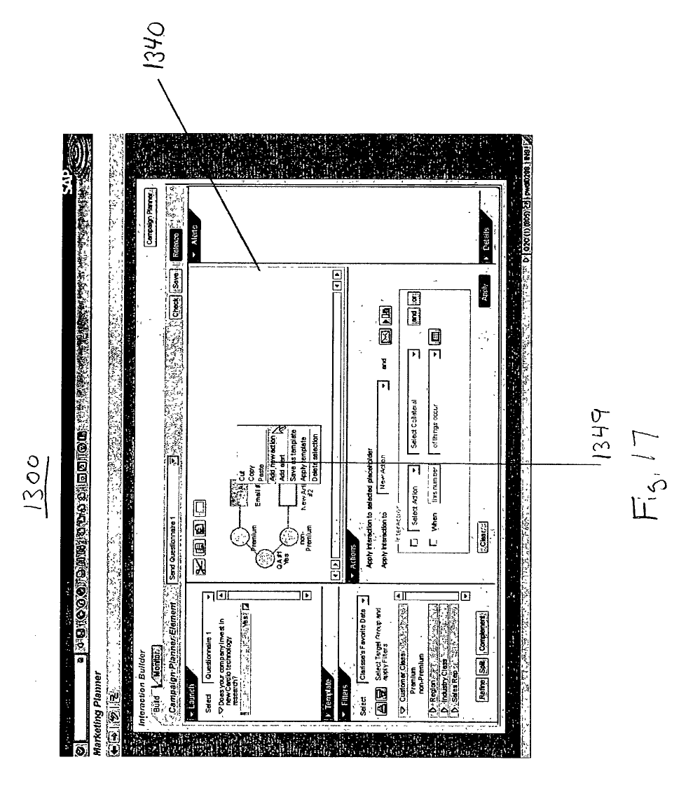

FIG. 17 illustrates an exemplary GUI that is presented to the user when the user performs a menu operation in the build window 1340. In this example, after completing the first action, the user moves her cursor into the build window 1340 and uses a right click to initiate the context menu. In the context menu, the user selects the option add new action 1349. This adds a new action placeholder to the nearest interaction node currently selected.

Alternatively, the user can create actions by selecting the add new action icon in the row of build buttons within the build window 1340.

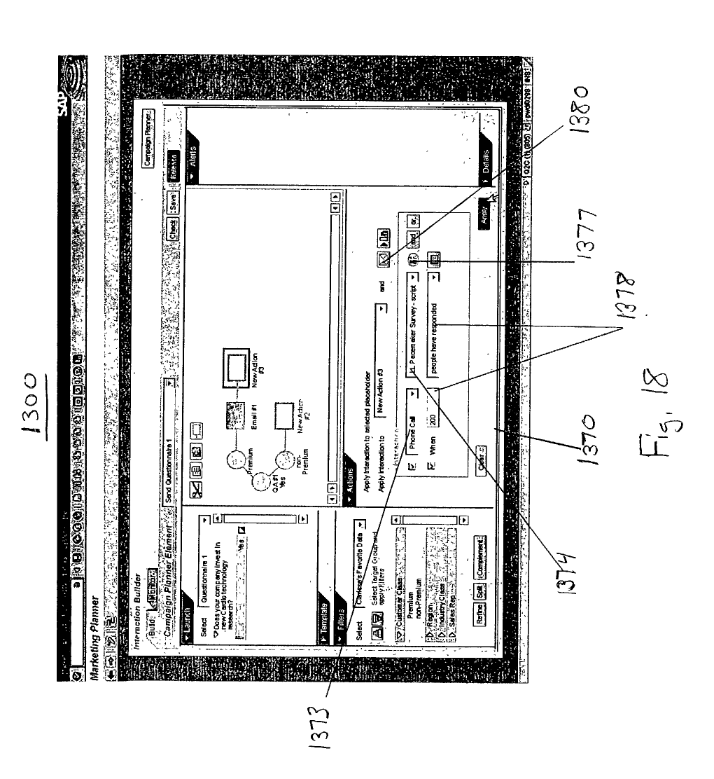

FIG. 18 illustrates an exemplary GUI 1300 that is presented to the user when the user defines actions using the actions window 1370. In this example, the user may define an action type for the new action created in FIG. 17. In this case, the user chooses “Phone Call” 1373 as the second action placeholder in this interaction string. Next, the user selects the related campaign element 1374. The drop-down list may be used to choose a call center script. Upon selection of the call center script 1374, the user notes that the script is an active campaign element 1377 as indicated by an icon to the right of the campaign element field. This means that the selected campaign element 1378 has defined attributes that could lead to additional interaction strings. This functionality allows the user to branch based on feedback received in the course of an interaction sequence. In this instance, the user intends for this new action to take place subsequent to a specific occurrence. Therefore, a dependency 1378 needs to be defined.

In this example, the user wants to initiate calls from the call center when 200 people have responded to the mailer. To do this, the user may manually enter 200 in the first dependency field 1378 and then select the phrase “people have responded” in the second dependency field 1378. The selections in the second dependency field may be configurable for company-specific usage. Additionally, the user wants to be notified by an instant message when the dependency 1378 is fulfilled. To receive a message related to this action, the user selects the Message me button 1380 to the right of the action definition fields. The action may be applied by selecting the Apply button.

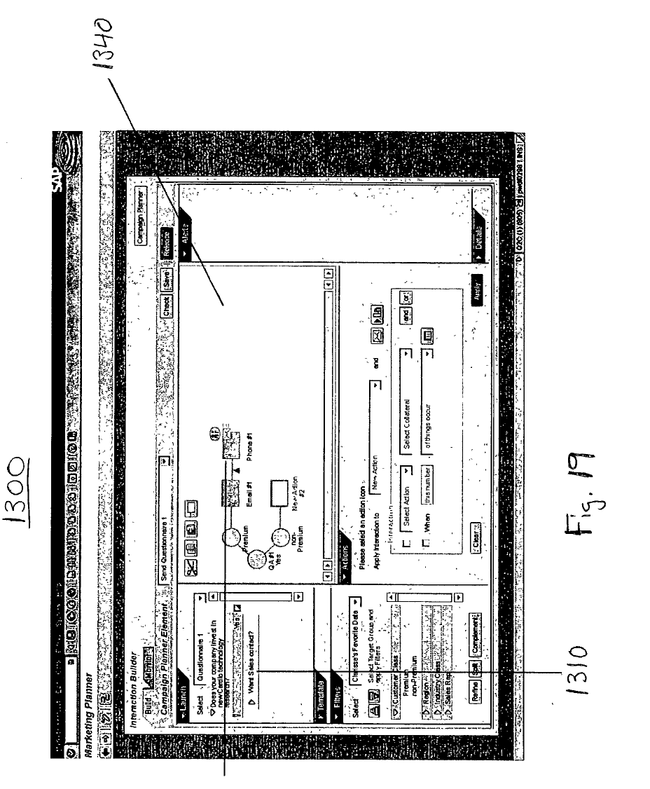

FIG. 19 illustrates an exemplary GUI 1300 that is presented to the user when the user applies the action as defined in FIG. 18. In this example, the message icon and the active campaign element icon are also displayed in the Build window 1340 for visual tracking. The dependency that was defined also is displayed, as indicated by a small triangle attached to the connector line between the first and second action icons. In the launch window 1310, the user now receives a visual display of the secondary set of attributes generated by selection of an active campaign element. To extend the interaction strings based on these secondary attributes, these new attributes may be selected in the Launch window 1310.

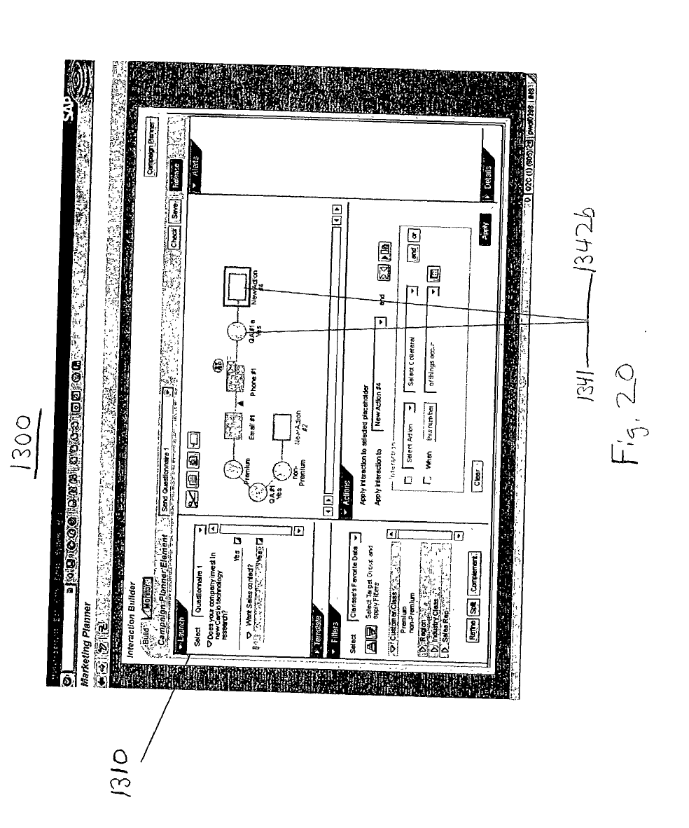

FIG. 20 illustrates an exemplary GUI 1300 that is presented to the user when the user selects a new attribute from the launch window 1310. Upon selection of a new attribute in the launch window 1310, a new target group 1341 is generated including an action placeholder 1342b for the selected attribute. At this time, the user may again conduct segmentation or proceed directly to action definition. In this case, the user chooses not to define another interaction based on the secondary attribute.

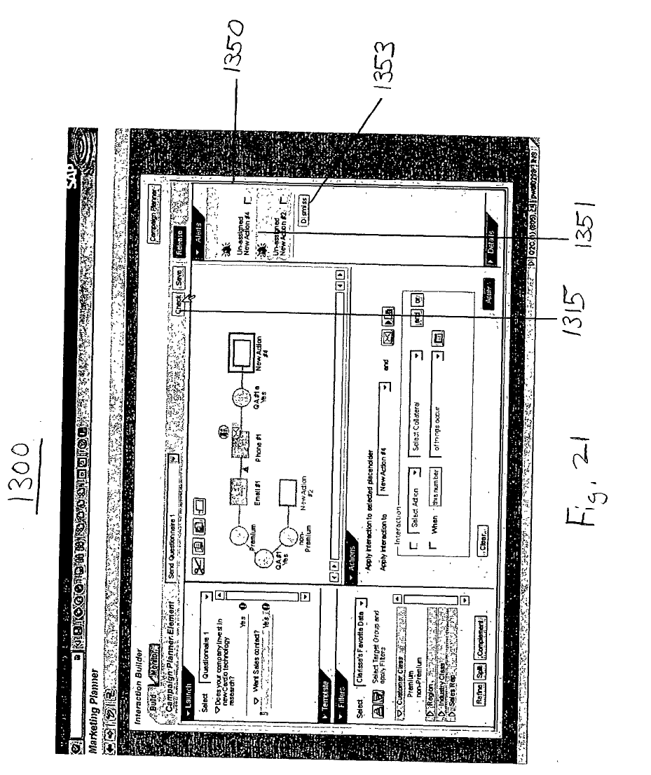

FIG. 21 illustrates an exemplary GUI 1300 that is presented to the user when the user checks the interaction sequences for errors, rule conflicts, and alerts. In this example, the user has completed building of the interaction sequence and selects the check button 1315 to check the work for errors, alerts, or rule conflicts. After the system runs a check, feedback regarding issues that require resolution is provided in the alerts window 1350. In this example, the user receives two alerts 1351 following the check: “Unassigned New Action #4” and “Unassigned New Action #2.” In this case, the alerts 1351 refer to the fact that two interaction sequences both end in action placeholders. Here, the user does not want to specify action for the empty placeholders. Therefore, the user chooses to override the alerts 1351 by the check box corresponding to each alert and then selecting the Dismiss button 1353.

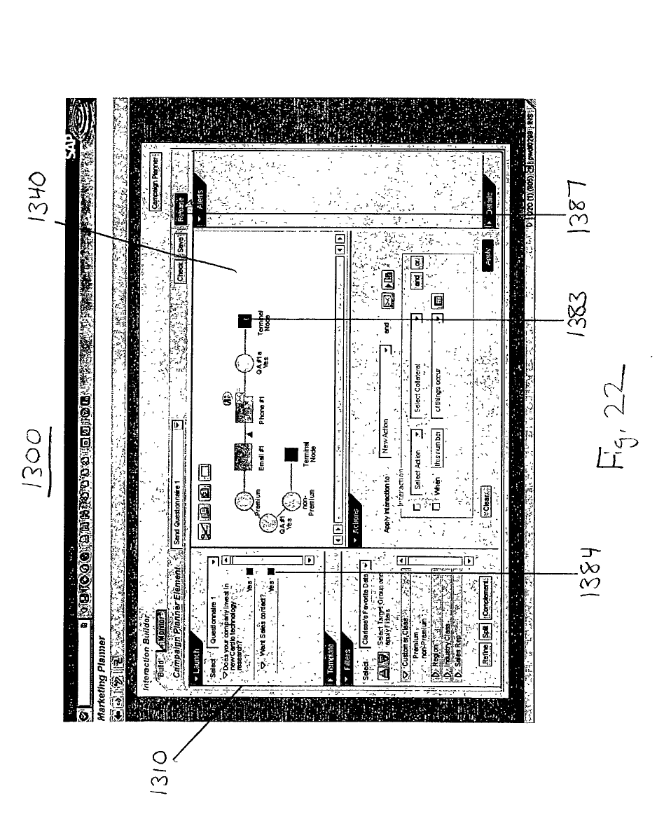

FIG. 22 illustrates an exemplary GUI 1300 that is presented to the user after the user dismisses the alerts illustrated in FIG. 21. After the alerts are dismissed, the build window 1340 provides feedback to indicate that the interaction sequences have been closed with the icon for a “terminal node” 1383. The icon for “Complete” also is displayed in the launch window 1310. After resolving alerts raised by the check, the status icons may be reviewed in the launch window 1310. A visual indication may be displayed to indicate completion and checked status of the interaction sequences. The interactions may be released by selecting the release button 1387.

Activating the release button 1387 causes the interaction sequences to be executed in an automated manner. For example, when the campaign is released, the action “Email 1” causes an automated interaction with an e-mail program.

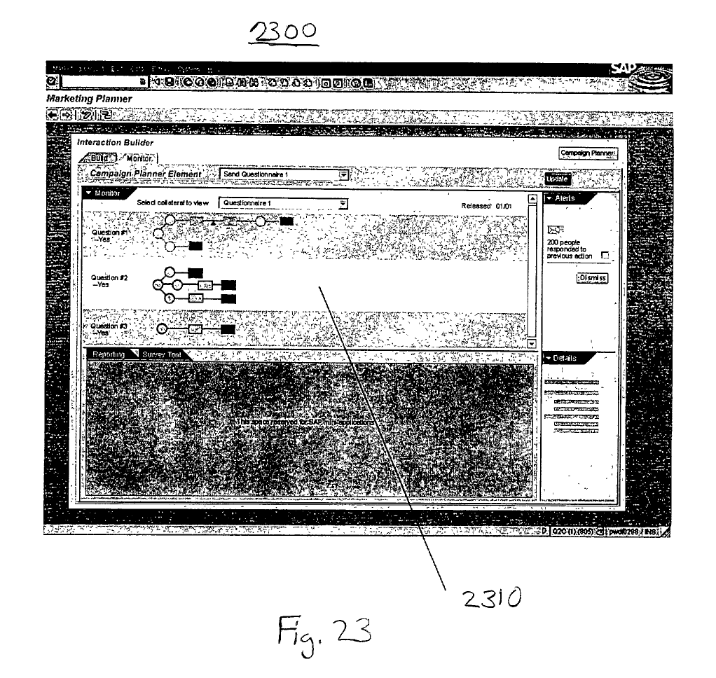

FIG. 23 illustrates an exemplary GUI 2300 that is presented to the user for monitoring the marketing campaign. For example, the user may receive an e-mail message informing the user that 200 people have now responded to the mailer. In the monitoring window 2310, the user is able to view multiple interaction sequences simultaneously. Messages may be received in the alerts area as duplicates to those sent by e-mail, and interaction string details may be viewed in the details area by highlighting a specific string.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for creating and monitoring automated interaction sequences for interactions with a target group during a marketing campaign using a graphical user interface, the method comprising:
receiving a user input that graphically creates an interaction sequence having one or more actions associated with a target group during a marketing campaign;
executing the interaction sequence to cause performance of the actions in an automated manner; and
automatically processing responses to the actions.

2. The method as in claim 1 wherein the actions include a first action and a second action.

3. The method as in claim 2 further comprising applying a dependency to the second action that causes the second action to depend on an automated response processed in response to the first action.

4. The method as in claim 1 wherein the actions include at least one of a send e-mail action, a send mail action, and an initiate phone call action.

5. The method as in claim 1 further comprising enabling the user to segment the target group by applying filters to the target group.

6. The method as in claim 5 wherein enabling the user to segment the target group includes receiving a user input that drags an attribute near the target group where one or more action areas in which to drop the attribute are presented.

7. The method as in claim 1 further comprising enabling the user to split the target group into multiple target groups and to create a separate interaction sequence for each of the target groups.

8. The method as in claim 1 further comprising enabling the user to monitor the interaction sequence.

9. The method as in claim 1 further comprising enabling the user to modify the interaction sequence based on the responses automatically processed.

10. The method as in claim 1 wherein the interaction sequences include marketing interaction sequences.

11. A method for creating and monitoring a marketing campaign using a graphical user interface, the method comprising:
creating a marketing interaction sequence having one or more actions associated with a customer target group using a graphical user interface;
releasing the marketing interaction sequence for automatic execution; and
receiving automatically-processed customer feedback related to the actions during execution of the marketing interaction sequence.

12. The method as in claim 11 further comprising monitoring the marketing interaction sequence using the graphical user interface.

13. The method as in claim 11 wherein creating the marketing interaction sequence includes:
creating a first action; and
creating a second action that is dependent on the received automatically processed customer feedback related to the first action.

14. The method as in claim 11 further comprising segmenting the customer target group by dragging an attribute near the customer target group, picking an action area in which to drop the attribute from one or more action areas presented when the attribute is dragged near the customer target group, and dropping the attribute in the picked action area.

15. The method as in claim 11 further comprising automatically checking for errors when the marketing interaction sequence is released.

16. A graphical user interface for creating and monitoring automated interaction sequences with a target group during a marketing campaign, comprising:
a launch window to select an attribute;
a build window to display an interaction sequence having one or more actions related to the selected attribute for interacting with a target group during a marketing campaign; and
an action window to define the actions graphically represented in the build window.

17. The graphical user interface of claim 16 further comprising a filter window to segment the selected attribute.

18. The graphical user interface of claim 16 further comprising an alerts window to display one or more alerts.

19. The graphical user interface of claim 16 further comprising a details window to display textual feedback related to selections made in other windows of the graphical user interface.

20. The graphical user interface of claim 16 further comprising a monitoring window to monitor automated responses to the interaction sequence.
